(19) United States
(12) Patent Application Publication
(10) Pub. No.: US 2013/0183500 A1
(43) Pub. Date: Jul. 18, 2013

(54) PRINTING METHOD

(71) Applicants: Vladek Kasperchik, Corvallis, OR (US); Vladimir Jakubek, Corvallis, OR (US); Vanessa Verzwyvelt, Vancouver, WA (US)

(72) Inventors: Vladek Kasperchik, Corvallis, OR (US); Vladimir Jakubek, Corvallis, OR (US); Vanessa Verzwyvelt, Vancouver, WA (US)

(21) Appl. No.: 13/352,569

(22) Filed: Jan. 18, 2012

(51) Int. Cl. B41J 2/01; B42D 15/00

(52) U.S. Cl. 428/207; 347/101

(57) ABSTRACT

A method for producing printed articles that encompasses providing a first ink composition that contains metal oxide particles with an average particle size in the range of about 3 to about 300 nm; providing a second ink composition that contains non-particulate, light-absorbing colorants dissolved in an ink vehicle; providing a printable media having a bottom supporting substrate and an ink-absorbing layer with pore diameters that are smaller than the size of the metal oxide pigment particles; and applying, on the same print area, the first and the second ink compositions onto said printable media. Also disclosed herein a the printed articles obtained according to the present method.

### BACKGROUND

Inkjet technology has expanded its application to high-speed, commercial and industrial printing, in addition to home and office usage, because of its ability to produce economical, high quality, multi-colored prints. This technology is a non-impact printing method in which an electronic signal controls and directs droplets or a stream of ink that can be deposited on a wide variety of substrates. Current inkjet printing technology involves forcing the ink drops through small nozzles by thermal ejection, piezoelectric pressure or oscillation, onto the surface of a media. In inkjet printing method, both the media and the ink play a key role in the overall image quality and permanence of the printed images and articles. Thus, it has often created challenges to find media and ink which can be effectively used with such printing techniques and which imparts good image quality. In addition, nowadays, prints and printed articles with specific characteristics and appearances are often wanted.

As expanded colors and appearances are sought for home and office decorative printing, developments have been made to provide printed articles with specific features, such as for examples, metallic appearances and/or reflectivity. However, method, inks and printed articles with such specific features are noticeably limited among available options due, for examples, to the cost or to the ineffectiveness for home and office use. Accordingly, investigations continue into developing printing methods and/or printed articles that exhibit specific properties such as, for example, metallic luster and/or variable color appearances.

### BRIEF DESCRIPTION OF THE DRAWING

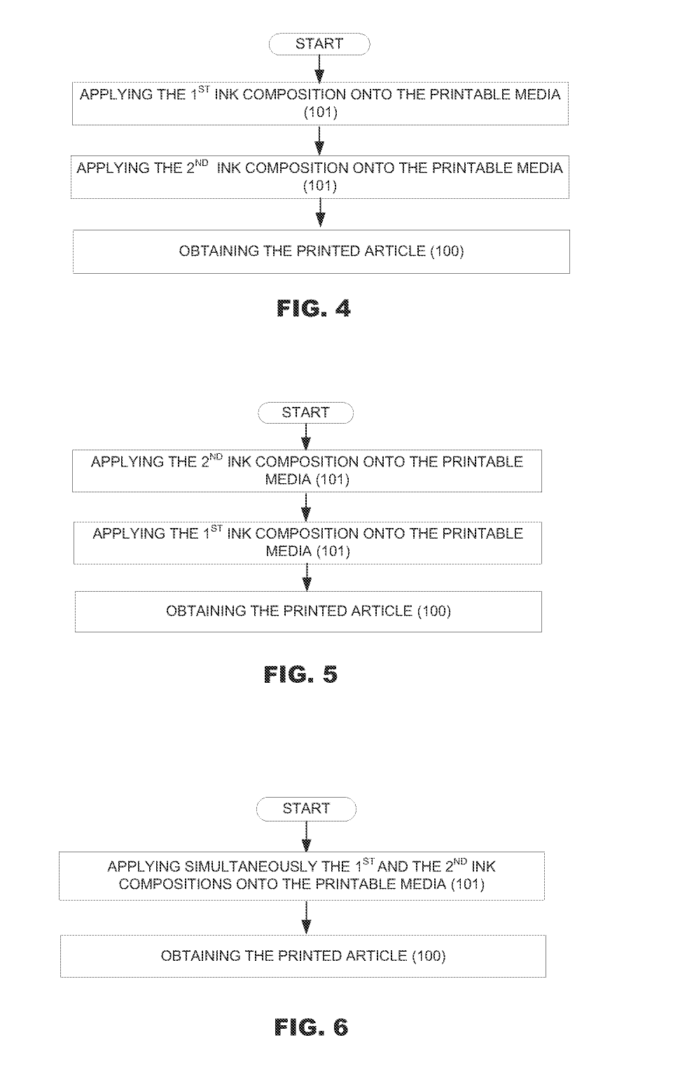

The drawings illustrate various embodiments of the present system and method and are part of the specification. FIGS. 1, 2 and 3 are cross-sectional views of a printed article and its printing method, according to some embodiments of the present disclosure. FIGS. 4, 5 and 6 are flowcharts illustrating methods for producing printed articles according to some embodiments of the present disclosure.

### DETAILED DESCRIPTION

Before particular embodiments of the present disclosure are disclosed and described, it is to be understood that the present disclosure is not limited to the particular process and materials disclosed herein. It is also to be understood that the terminology used herein is used for describing particular embodiments only and is not intended to be limiting, as the scope of protection will be defined by the claims and equivalents thereof. In describing and claiming the present article and method, the following terminology will be used: the singular forms “a”, “an”, and “the” include plural referents unless the context clearly dictates otherwise. Thus, for example, reference to “a pigment” includes reference to one or more of such materials. Concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For examples, a weight range of about 1 wt % to about 20 wt % should be interpreted to include not only the explicitly recited concentration limits of 1 wt % to 20 wt %, but also to include individual concentrations such as 2 wt %, 3 wt %, 4 wt %, and sub-ranges such as 5 wt % to 15 wt %, 10 wt % to 20 wt %, etc. All percents are by weight (wt %) unless otherwise indicated.

The disclosure describes a method of producing printed articles with metallic luster and variable color appearance. Such method encompasses applying, on the same print substrate area, two different ink compositions, herein called first ink composition and second ink composition. The method encompasses providing a first ink composition that contains metal oxide particles with an average particle size in the range of about 3 to about 300 nm; providing a second ink composition that contains non-particulate, light-absorbing colorants dissolved in an ink vehicle; providing a printable media having a bottom supporting substrate and an ink-absorbing layer with pore diameters that are smaller than the size of the metal oxide pigment particles; and applying, on the same print area, the first and the second ink compositions onto said printable media.

The present disclosure also describes the printed article resulting from said method, having metallic luster and variable colored appearance, that encompasses a printable media on which a printed feature has been formed by applying, on the same print area, a first and a second ink compositions. The first ink composition can be called “metallic luster” ink and is based on dispersed conductive metal oxide nanoparticles. The second ink composition is a colored ink that contains soluble colorants (such as dyes) in a dissolved state. Both the first and the second ink compositions are jetted onto a printable media having a micro-porous absorptive surface. The pores, present on the media, are small enough to retain the metal oxide particles, part of the first ink composition, on the media surface while non-particulate, light-absorbing colorants, part of the second ink composition, are capable of penetrating into the media to form a colored layer below the reflective semi-transparent metal oxide layer.

The printing method, as described herein, enables thus the production of printed articles having a wide variety of different metallic colors while utilizing single “metallic luster” metal oxide ink. The printing method can be a digital technology and can be considered as a “color-on-demand” flexibility: i.e. color can easily be changed or modified. Said printing method enables hue flexibility of metallic prints by simultaneous jetting or overlaying on the same print area using two different types of inkjet ink. The resulting printed article has thus a reflective “metallic” appearance with hue highly dependent on color of the dye-based ink, colorant content in it and ratio of both ink fluxes (metal oxide and dye-based ones). In addition, said printing method enables the creation of text and graphic prints with metallic color appearance on paper-like substrates.

The Printing Method

The method for producing printed articles having a metallic luster and a variable color appearance, encompasses providing a first ink composition that contains metal oxide particles having an average particle size in the range of about 3 to about 300 nm; providing a second ink composition that contains a non-particulate, light-absorbing colorant dissolved in an ink vehicle; providing a printable media, containing a bottom supporting substrate and an ink-absorbing layer with pore diameters that are smaller than the size of the metal oxide pigment particles; and jetting, on the same print area, the first and the second ink compositions onto said printable media.

Both the first and the second ink compositions are inkjet compositions; it is thus meant that said compositions are very well adapted to be used in an inkjet device and/or in an inkjet printing process. Said ink compositions may be established on the material via any suitable inkjet printing technique. Non-limitative examples of such inkjet printing technique include thermal, acoustic, continuous and piezoelectric inkjet printing.

By inkjet printing technique, it is meant herein that the ink is applied using inkjet printing devices. Within inkjet printing devices, liquid ink drops are applied in a controlled fashion to a print medium by ejecting ink droplets from a plurality of nozzles, or orifices, in a printhead of an ink jet printing device or inkjet printer. In some examples, ink compositions may be dispensed from any piezoelectric or drop-on-demand inkjet printing devices. Such inkjet printing devices can be available from Hewlett-Packard Inc., Palo Alto, Calif., by way of illustration and not limitation. In drop-on-demand systems, a droplet of ink is ejected from an orifice directly to a position on the surface of a print medium by pressure created by, for example, a piezoelectric device, an acoustic device, or a thermal process controlled in accordance digital data signals. An ink droplet is not generated and ejected through the orifices of the printhead unless it is needed. The volume of the ejected ink drop is controlled mainly with a print head. The printed or jetted ink may be dried after jetting the ink composition in a predetermined pattern onto a surface of a print medium. The drying stage may be conducted, by way of illustration and not limitation, by hot air, electrical heater or light irradiation (e.g., IR lamps), or a combination of such drying methods. In order to achieve best performance it is advisable to dry the ink at a maximum temperature allowable by the print medium that enables good image quality without print medium deformation. In some examples, a temperature during drying is about 40° C. to about 150° C.

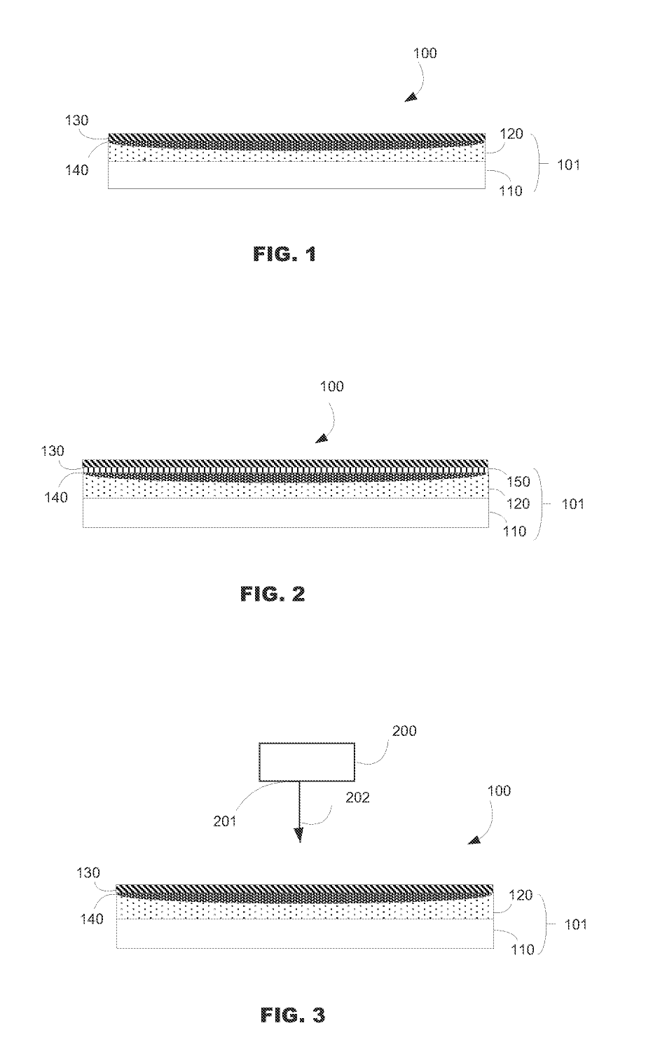

FIG. 1 and FIG. 2 illustrate embodiments of the printed article (100) resulting from the printing method described herein. Such printed article (100) encompasses a metal oxide coating layer (130) that is applied over a printable media (101). Said printable media (101) encompasses a bottom supporting substrate (110) and an ink-absorbing layer (120). Such illustrated in FIG. 2, the printable media (101) might further encompass a glossy layer (150) that is located above the ink-absorbing layer (120). The printed article (100) encompasses also a colored absorbed area (140), containing the second ink composition which has been absorbed into the ink-absorbing layer (120). The printed article (100) contains thus a metal oxide coating layer (130) that is deposited at the surface of the ink-absorbing layer (120) or, when present, at the surface of the glossy layer (150), and a colorant absorbed area (140), located into the ink-absorbing layer (120) that lies substantially below the metal oxide coating layer (130) or, when present, below the glossy layer (150).

The metal oxide coating layer (130) is applied on the coated side of the printable media (101). If said coated side is used as an image-receiving side, the other side, i.e. backside, may not have any coating at all, or may be coated with other chemicals (e.g. sizing agents) or coatings to meet certain features such as to balance the curl of the final product or to improve sheet feeding in printer. In some examples, ink-absorbing layers (120) and, when present, the glossy layer (150), are applied to both opposing sides of the supporting substrate (110). The double-side coated medium has thus a sandwich structure, i.e. both sides of the supporting substrate (110) are coated with the same coating and both sides may be printed with metal oxide coating layers (130).

FIG. 3 illustrates an example of the method according to the present disclosure and an example for forming the printed article such as illustrated in FIG. 1. In such method, the printer (200) has, at least, one orifice (201) that dispenses droplets of the first and of the second ink compositions, in accordance with the principles described herein, along a trajectory (202) to the surface of printable media (101) in view of forming a printed feature. Said printed feature contains metal oxide particles that are retained at the surface of the ink-absorbing layer (120) and forms metal oxide coating layer (130). The second ink composition, having soluble colorants, are absorbed and passes into the ink-receiving layer (120) to form a colored absorbed area (140), which is adjacent and corresponds to the metal oxide coating layer (130) deposited onto the ink-receiving layer (120).

In some examples, such as illustrated in the FIG. 4, the first ink composition is applied before the second ink composition on the same print area of the printable media (101) in view of obtaining the printed article (100). In some other examples, such as illustrated in the FIG. 5, the second ink composition is applied first and then the first ink composition is applied, on the same print area of the printable media (101), in view of obtaining the printed article (100). In yet some other examples, such as illustrated in the FIG. 6, the first and the second ink compositions are applied simultaneously on the same print area of the printable media (101) view obtaining the printed article (100). The projection of stream of droplets of both the first and the second ink compositions, onto the printable media, can be done via inkjet printing technique.

Both the first and the second ink compositions are jetted onto the surface of the printable media (101), which contains a bottom supporting substrate (110) and an ink-absorbing layer (120), and, eventually, a glossy layer (150). The pore sizes of the ink-absorbing layer (120) and, when present, of the glossy layer (150) are small enough to retain practically all metal oxide particles on the surface while, in the same time, absorbing the liquid phase of both ink compositions into the media.

The ink fluxes for both the first and second ink compositions may vary. The combined or sequential flux of both the first and second ink compositions, i.e. total flux, that is applied on the printable media during the printing process is lower than the absorptive capacity of the printable media. Such absorptive capacity varies for different porous media designs but can be in the range of between 90 and 180 pL/300^{th} pixel. In some examples, the total ink flux is below 100% of the printable media absorbing capacity and, in some other example, is below or equal to 80% of the printable media absorbing capacity.

The ink flux, of the first ink composition, is in a range enabling formation of continuous reflective metal oxide coating with maximized directional light reflectivity. In some examples, when the first ink composition contains about 2 wt % of Fe₃O₄ particles, the optimum ink flux is ranging between 35 and 120 pL/300^{th} pixel (1/300×1/300 inch square or 4800 to 17000 pL/mm²). The ink flux of the second ink composition may vary within a wide range but is lower than the ink flux observed for the first ink composition. In some examples, the ink flux of the second ink composition is two time, or more than two times, lower than the flux of the first ink composition. The upper limit of the ink flux for the second ink composition is the media absorbing capacity minus the flux of the first ink composition. There is no lower limit of the flux value for the second ink composition; however, the tower is the flux, the lower is the second ink composition impact on hue of the resulting metallic color printed article.

Printed Article

In some examples, the jetting of the first ink composition, that contains metal oxide particles, and the jetting of the second ink composition, that contains non-particulate, light absorbing colorants, result in printed articles (100) with metallic color appearance. The non-particulate, light-absorbing colorants migrate with the liquid phase into the ink-absorbing layer (120) of the printable media (101) while metal oxide particles, that are part of the first ink composition, form a reflective metal oxide layer (130) on the print surface.

Absorption of the liquid phase of the first ink composition, containing the metal oxide particles, into media porosity of the ink-absorbing layer (120) and retention of said metal oxide particles on the surface, results in the formation of a print surface with a highly planarized metal oxide layer (130). The second ink composition, that contains a non-particulate, light-absorbing colorant, does not have separate solid phase and is absorbed into the ink-absorbing layer (120) in view of forming the colored absorbed area (140) that is located below the metal oxide layer (130). Thus, the different types colorants are spatially separated: the dye-colorants ending up in the ink-absorbing layer (120) of the printable media while the metal oxide particles forms a highly planarized optically reflective layer (130) in top of the ink-absorbing layer (120) containing dye colorants. Such combination of color and aspect results in a printed article with metallic luster and variable color appearance. The variable color is dependant of the color of the area (140), i.e. the nature of the colorant present in the second ink composition.

Therefore, in some embodiments, the printed article that results from the printing method described herein has a metallic luster and variable colored appearance. The metallic color appearance is the result of light directional reflection from the combination of air, metallic layer (130) and media surface, as well as from the diffuse light reflection coming from the absorbed area (140) that is colored in presence of absorbed dye colorants.

The printed article (100) encompass a printable media (101) on which a printed feature has been formed by applying, on the same print area, a first and a second ink compositions. Said first ink composition contains metal oxide particles that have an average particle size in the range of about 3 to about 300 nm and forms a metal oxide coating layer (130). Said second ink composition contains non-particulate, light-absorbing colorants dissolved in an ink vehicle and forms a colorant absorbed area (140). Said printable media (101) contains a bottom supporting substrate (110) and an ink-absorbing layer (120) with pore diameters that are smaller than the size of the metal oxide pigment particles. In some examples, the printable media (101) can further contain a glossy layer (150).

In some examples, the first ink composition forms a metal oxide coating layer (130) at the surface of the ink-absorbing layer (120) of the printable media (101) and the second ink composition forms a colorant absorbed area (140) into the ink-absorbing layer (120) and below the metal oxide coating layer (130).

In some examples, for optimum metallic appearance, the metal oxide coating layer (130) is a planarized optically reflective layer (130), that encompasses metal oxide particulates, with a thickness that is in the range of about 1 and about 600 nm, or, between about 3 and about 300 nm. In some other examples, the metal oxide coating layer has a density in the range about 3 to about 80 μg/cm² or a density in the range of about 10 to about 40 μg/cm². Said metal oxide layer (130) can be optically transparent or semi-transparent. The transparency allows to see the colored absorbed area (140) present in the ink-absorbing layer (120).

The resulting printed (100) has a uniform coating with strong sparkling and metallic reflective appearance. By “metallic luster”, it is meant herein that the printed article has an opaque or a semi-opaque appearance and reflects the light as a metal reflects it. The printed article interacts with the light and has a shiny metal appearance. The printed article has thus specific optical properties: it exhibits a sort of glow from reflected light and has the tendency to reflect at specular angle when exposed to directional light source. In some examples, the printed article can have a gold appearance. By “gold-like appearance”, it is meant herein that the printed article has a visual appearance of gold-plated surface and has the color of metallic gold (Au). However, the printed article does not contain any gold or other elemental metal particles. The printed article exhibits thus gloss and sheen as a gold object does. By “variable colored appearance”, it is meant herein that the printed article could have different color, such variable color being dependant of the color of the area (140), i.e. of the nature of the light-absorbing colorant present in the second ink composition. In some examples, the colored area (140) contains light-absorbing colorants that are selected from the group consisting of yellow dyes, cyan dyes, magenta dyes, and combinations of two or more of the above. The colored appearance could then be slightly yellow, cyan, magenta, or any other colors resulting from the combination of the above mentioned colorants. Such combination of color and aspect provided by the reflective metal oxide layer (130) and by the colored absorbed area (140) results in a printed article with metallic luster and variable color appearance.

The printed article can be useful for forming printed images that have, for examples, decorative applications, such as greeting cards, scrapbooks, brochures, book covers, signboards, business cards, certificates and other like applications. In some other examples, such printed article can be used as printed media used in printing techniques.

The First Ink Composition

The first ink composition, also called “metallic luster” ink composition, is based on dispersed metal oxide particles. The “metal oxide particles” are nanoparticles that have size in a range such that they are substantially transparent to the naked eye. The metal oxide particles are either colorless or have rather weak coloration in thin layers. Said metal oxide particles have an average particle size in the range of about 3 to about 300 nm. The average size of the metal oxide particles may also be in the range of about 10 to about 100 nm; in some other examples, in the range of about 20 to about 60 nm.

The refractive index of the metal oxide particles can be equal or higher than 1.2. In some examples, the refractive index of the metal oxide particles is in the range of about 1.5 to about 3.0. The refractive index, or index of refraction, is a measure of the speed of light in metal oxide particles, it is expressed as a ratio of the speed of light in vacuum relative to that in the particles medium.

Metal oxide particles include metal oxide pigments selected from the group consisting of titanium dioxide (TiO₂), in rutile or anatase crystalline form, zinc oxide (ZnO), indium oxide (In₂O₃), manganese oxide (Mn₃O₄) and iron oxide (Fe₃O₄). In some examples, the metal oxide particles are iron oxide (Fe₃O₄) or manganese oxide (Mn₃O₄) particles. In some other examples, the first ink composition contains iron oxide (Fe₃O₄) as metal oxide particles. As “iron oxide”, it is meant herein any chemical compounds composed of iron and oxygen. The term iron oxide encompasses thus different iron oxides, iron hydroxides or oxide/hydroxides. Examples of iron oxides include iron (II) oxide (wüstite, FeO), iron (II, no oxide (magnetite, Fe₃O₄) and iron (III) oxide (hematite, Fe₂O₃). Examples of iron hydroxides include iron (II) hydroxide (Fe(OH)₂) and iron (III) hydroxide (Fe(OH)₃). In some examples, the first ink composition contains magnetite (Fe₃O₄) as metal oxide pigment.

Metal oxide particles might have a light absorptivity that is similar to that of metals. In some examples, inks based on dispersions of these materials may form coatings with reflectivity up to 10% (or even higher) and with a visual appearance of metallic films. When printed articles are made with a first ink composition containing Fe₃O₄ particles, such printed articles may have visual appearance of gold.

In some embodiments, the metal oxide particles are dispersed in a liquid carrier in view of forming a jettable ink composition that is suitable for inkjet printing. In some examples, the ink composition is an inkjet ink composition that contains, at least, metal oxide particles and an aqueous carrier. In some other examples, the first ink composition contains a metal oxide, a dispersant and a liquid carrier.

The amount of the metal oxide particles, present in the first ink composition, can represent from about 0.1 to about 30 wt % of the total weight of the ink composition. In some examples, the amount of metal oxide particles represents from about 0.5 to about 20 wt %, and, in some other examples, from about 1 to about 10 wt % by total weight of the ink composition. In some embodiments, the metal oxide particles is Fe₃O₄ particles and represents from about 1.5 to about 5 wt % by total weight of the ink composition.

In some examples, the first ink composition also contains a dispersant in an amount sufficient to achieve a predetermined jetting reliability for the ink composition; i.e. the metal oxide particles, present in the first ink composition, are dispersed with dispersants. Examples of suitable dispersants include, but are not limited to, water-soluble anionic species of low and high molecular weight such as phosphates and polyphosphates, phosphonates and polyphosphonates, phosphinates and polyphosphinates, carboxylates (for example, citric acid or oleic acid), polycarboxylates (for example, acrylates and methacrylates), hydrolysable alkoxysilanes with alkoxy group attached to water-soluble (hydrophilic) moieties such as water-soluble polyether oligomer chains (for example, polyether alkoxysilanes). The dispersant can be reactive silane coupling agents containing hydrophilic functional groups, such as amino, diamino, triamino, ureido, poly(ether), mercapto, glycidol functional groups and their hydrolysis product. Examples of silane coupling agents suitable as dispersants for metal oxide particles are (aminoethyl) aminopropyl-triethoxysilane, (aminoethyl) aminopropyl-trimethoxysilane, (aminoethyl) aminopropyl-methyldimethoxysilane, aminopropyl-triethoxysilane, aminopropyl-trimethoxysilane, glycidolpropyl-trimethoxysilane, ureidopropyltrimethoxysilane and polyether-triethoxysilane, polyether-trimethoxysilane hydrolysis product of aminopropyl-trimethoxysilane and hydrolysis product of (aminoethyl) minopropyl-trimethoxysilane. In some examples, the dispersant used in the first ink composition, to disperse metal oxide particles, is a polyether alkoxysilane dispersant. The amount of dispersant in the first ink composition is dependent, for example, on one or more of the nature of the dispersant, the nature and the amount of the metal oxide, the nature of the ink-receiving layer, and the nature of the jetting instrument. In some examples, the amount of dispersant may vary from about 1 wt % to about 300 wt % of the dispersed metal oxide particles content. In some examples, the dispersant content range is between about 2 and about 150 wt %, or, in some other examples, is between about 5 and about 100 wt % of the metal oxides particles content.

In some examples, the first ink composition contains magnetite (Fe₃O₄) as metal oxide particles, dispersed in an aqueous liquid vehicle. The dispersion of iron oxide particles, such as Fe₃O₄, can be prepared via milling or dispersing Fe₃O₄ powder in water in the presence of suitable dispersants. The metal oxide dispersion, may be prepared by milling commercially available inorganic oxide pigment having large particle size the micron range) in the presence of the dispersants, described above, until the desired particle size is achieved. The starting dispersion to be milled is an aqueous dispersion with solid content up to 40% by weight of the metal oxide pigment. The milling equipment that can be used is a bead mill, which is a wet grinding machine capable of using very fine beads having diameters of less than 1.0 mm as the grinding medium, for example, Ultra-Apex Bead Mills from Kotobuki Industries Co Ltd. The milling duration, rotor speed and temperature may be adjusted as known to those skilled in the art to achieve the results desired.

The Second Ink Composition

The second ink composition contains a non-particulate, light-absorbing colorant that is dissolved in a liquid vehicle. The non-particulate, light-absorbing colorant can be a water-soluble dye compound that provides a color. The phrase “non-particulate” means that the compound forms a molecular solution (the colorant is soluble) in the liquid vehicle and passes into, and is absorbed by, the ink-receiving layer of the printable media, with little or no retention on the surface of the ink-receiving layer as distinguished from the metal oxide pigment presents in the first ink, which has a particulate nature and is subject to retention at the surface of the ink-receiving layer. The phrase “light-absorbing” refers to the ability of the compound to absorb light rather than reflect or transmit light. The light absorbing compound has little, if any, significant negative impact on directional surface reflectivity of a printed medium.

The light-absorbing colorants can have light in the visible range or in the range of about 400 nm to about 700 nm. The color of the colorant compound may be, but is not limited to, yellow, cyan, magenta, green, red, black, and orange, for example, and combinations of two or more of the above. In some examples, said particulate, light-absorbing colorants are dyes.

In some examples, the second ink composition contains non-particulate, light-absorbing colorants that are selected from the group consisting of yellow dyes, cyan dyes, magenta dyes, and combinations of two or more of the above. Examples of dyes suitable for use in the preparation of the ink composition include, but are not limited to, the yellow dyes such as C.I. Yellow 19 (C.I. 13900A), C.I. Yellow 21 (C.I. 18690), C.I. Yellow 61, C.I. Yellow 80, FD&C Yellow #5, and the like; the orange dyes such as C.I. Orange 1 (C.I. 11920), C.I. Orange 37, and the like; red dyes such as C.I. Solvent Red 8, C.I. Red 81, C.I. Solvent Red 82, and the like; pink dyes such as Diaresin Pink M (Mitsubishi Chemical Industries, Ltd.), and the like; violet dyes such as C.I. Solvent Violet 8, and the like, blue dyes such as C.I. Solvent Blue 2, C.I. Solvent Blue 11, and the like; and black dyes such as C.I. Solvent Black 3, Acid Black 123, Reactive Black 31 and the like.

In addition, further examples of yellow dyes include, but are not limited to, AY17, AY23, RY181, DY86, and DY132, and combinations of two or more of the above. Further examples of cyan dyes include, but are not limited to, Cyan Dye 1 (HCE®, Nippon Kayaku Co. Ltd., Tokyo, Japan), DB 199, AB9, C485, and C854, and combinations of two or more of the above. Further examples of magenta dyes include, but are not limited to, AR52, AR249, AR289, DR23, DR75, DR227, RR120, pacified RR120, Reactive Red 180, pacified RR180, RR23, and RR24, and combinations of two or more of the above. Examples of green dyes include, also, but are not limited to, AG1, AG41, and BG4, and combinations of two or more of the above.

The nature and the amount of the non-particulate, light-absorbing colorant in the liquid vehicle is sufficient to render a predetermined hue to the media when applied to form a printed article. The colorant is present in an amount required to produce the desired color, contrast and readability. The nature of the colorant is also dependent on the nature of the metal oxide and on the nature of the ink-receiving layer, for example.

The non-particulate, light-absorbing colorant can be present, in the second ink composition, in an amount representing from about 0.001 to about 10 percentage by weight (wt %); in some other examples, in an amount representing from about 0.01 to about 5 wt %, and in yet some other examples, in an amount representing from about 0.1 to about 1 wt % by total weight of the second ink composition. Adjusting the amount of the non-particulate light-absorbing colorant, in the second ink composition, allows controlling the hue of the printed article resulting from the printed method as described herein

Liquid Vehicle and Other Ingredient of the First and Second Ink Compositions

As disclosed herein, the first ink composition contains metal oxide particles and the second ink composition contains non-particulate, light-absorbing colorant that are dispersed or dissolved in a liquid vehicle. “Liquid vehicle” is defined to include any liquid composition that is used to carry the metal oxide particles or the light-absorbing colorant to the substrate. A wide variety of liquid vehicle components may be used herein. Such vehicle may include a mixture of a variety of different agents, including without limitation, surfactants, solvent and co-solvents, buffers, biocides, viscosity modifiers and water. Both the first and second ink composition encompasses, thus, a liquid vehicle that are chosen independently. In some examples, the liquid vehicle is an inkjet liquid vehicle.

Organic solvents can be part of the liquid vehicle. Suitable organic solvents include polar solvents such as amides, esters, ketones, lactones and ethers. Examples of organic solvents also include N-methylpyrrolidone (NMP), dimethyl sulfoxide, sulfolane, and glycol ethers. The solvent can be used in an amount representing from about 0.1 to about 30 wt % of the ink composition or can be used in an amount representing from about 8 to about 25 wt % of the ink composition. The ink compositions can include water. Such water can be used as the ink carrier for the composition and can be part of the liquid vehicle. The water can make up the balance of the ink composition, and may be present in an amount representing from about 40 to about 95% by weight of the total composition. In addition to water, various types of agents may be employed in the ink composition to optimize the properties of the ink for specific applications.

Surfactants can also be used in the first and in the second ink compositions and may include, for example, anionic surfactants such as, for example, sodium dodecylsulfate, sodium dodecyloxysulfonate and sodium alkylbenzenesulfonate; cationic surfactants such as, for example, cetylpyridinium chloride, trimethylcetylammonium chloride and tetrabutylammonium chloride; and nonionic surfactants such as, for example, polyoxyethylene nonylphenyl ether, polyoxyethylene naphthyl ether and polyoxyethylene octylphenyl ether. Other surfactants include, but are not limited to, amphoteric surfactants, silicon-free surfactants, ethoxylated surfactants, fluorosurfactants, alkyl polyethylene oxides, alkyl phenyl polyethylene oxides, polyethylene oxide block copolymers, and polysiloxanes, for example, and combinations thereof. If used, the surfactant can be present at a level ranging from about 0.001 to about 10 wt %, or at a level ranging from about 0.01 to about 3 wt % of the ink composition.

Biocides and anti-foaming agents can also be used in the first and in the second ink compositions. Examples of suitable biocides include, but are not limited to, benzoate salts, sorbate salts, commercial products such as Nuosept® (Ashland Special Ingredients, Wayne N.J.), Ucarcide® (Dow Chemical Company, Midland Mich.), Vancide® (RT. Vanderbilt Company, Inc., Norwalk Conn.), Proxel® (Avecia OligoMedicines, Inc., Milford Mass.), and Kordek® MLX (Dow Chemical Company), for example. Such biocides may be contained in amount representing less than about 5 weight percentage of the ink composition. Examples of commercially available anti-foaming agents include, but are not limited to, FOAMEX® 800, FOAMEX® 805, FOAMEX® 845, FOAMEX® 842, FOAMEX® 835, (all available from Evonik Tego Chemie Service GmbH, Essen, Germany) and TWIN® 4000 (Evonik Tego Chemie Service GmbH); BYK® 019, BYK® 028, BYK® 029 (available from BYK Chemie GmbH, Wesel, Germany); and SURFYNOL® 104PG50, SURFYNOL® MD30 (all available from Air Products and Chemicals, Inc., Allentown Pa.), for example.

The pH of the both the first and second ink composition can be, independently, in the range of about 3 to about 10. In some examples, the pH of the ink is from about 5 to about 10 and, in some other examples, from about 5.5 to about 7.5. The pH of the ink composition may be adjusted by addition of organic or inorganic acids or bases, i.e. pH adjusting agent. Both the first and second ink composition can have, independently, a viscosity within the range of about 1.0 to about 10 cps, or within the range of about of about 1.0 to about 7.0 cps, as measured at 25° C., in order to achieve the desired rheological characteristics.

Printable Media

The printable media (101) used in the above mentioned printing method contains a bottom supporting substrate (110) and an ink-absorbing layer (120). Said ink-absorbing layer (120) has pore diameters that are smaller than the average size of the metal oxide pigment particles, present in the first ink composition. Said ink-absorbing layer is thus capable of absorbing the liquid phase of the first ink into the pores while retaining the metal oxide particles on the print surface. Without being linked by any theory, it is believed that such sucking action of the ink-absorbing layer (120) forces the metal oxide particles to form the thin smooth metal oxide layer, i.e. the printed feature that will have good optical reflectivity. In addition, said ink-absorbing layer is also capable to absorb completely the second ink composition, that contains non-particulate, light-absorbing colorants dissolved in an ink vehicle. Said ink-absorbing layer (120) has pore diameters that are smaller than 300 nm; in some examples, that are smaller than 200 nm; in some other examples that are smaller than 150 nm.

In some examples, the ink-absorbing layer (120) has an absorption capacity ranging from about 0.6 to about 1.2 liter/gram. In some other examples, the porous ink-absorbing layer (120) has a coat-weight in the range of about 10 to 40 g/m² or in the range of about 15 to about 30 g/m².

The ink-absorbing layer (120) can include inorganic pigments in particulate form and, at least, one binder. Suitable inorganic pigments include metal oxides and/or semi-metal oxides particles. The inorganic semi-metal oxide or metal oxide particles may be independently selected from silica, alumina, boehmite, silicates (such as aluminum silicate, magnesium silicate and the like), titania, zirconia, calcium carbonate, clays, or combinations thereof. The inorganic pigment can be fumed alumina or fumed silica. The inorganic particles pigments can include any number of inorganic oxide groups including, but not limited to silica and/or alumina, including those treated with silane coupling agents containing functional groups or other agents such as aluminum chloro-hydrate (ACH) and those having oxide/hydroxide. If silica is used, it can be selected from the following group of commercially available fumed silica: Cab-O-Sil®LM-150, Cab-O-Sil®M-5, Cab-O-Sil®MS-55, Cab-O-Sil®MS-75D, Cab-O-Sil®MS-5, Cab-O-Sil®EH-5, Aerosil®150, Aerosil®200, Aerosil®300, Aerosil®350 and/or Aerosil®400. The aggregate size of the fumed silica can be from approximately 50 to 300 nm in size. The Brunauer-Emmett-Teller (BET) surface area of the fumed silica can be from approximately 100 to 400 square meters per gram. The inorganic particles pigments can be alumina (modified or unmodified). The alumina coating can comprise pseudo-boehmite, which is aluminum oxide/hydroxide (Al₂O₃n H₂O where n is from 1 to 1.5). Commercially available alumina particles can also be used, including, but not limited to, Sasol Disperal® HP10, Disperal®HP14, boehmite, Cabot Cab-O-Sperse®PG003 and/or CabotSpectrAl®81 fumed alumina.

In some examples, the ink-absorption layer (120) contains fumed silica or fumed alumina that are aggregates of primary particles that have an average particle size ranging from about 120 nm to about 250 nm. The amount of inorganic pigment may be from about 30 to 90 by weight (wt %) based on the total weight of the ink-absorbing layer. A binder can be added to the ink-absorption layer (120) to bind the particulates together. In some examples, the binders are water-soluble polymers and polymer latexes. Examples of binders, for use herein, include, but are not limited to polyvinyl alcohols and water-soluble copolymers thereof, e.g., copolymers of polyvinyl alcohol and poly(ethylene oxide) or copolymers of polyvinyl alcohol and polyvinylamine; cationic polyvinyl alcohols; aceto-acetylated polyvinyl alcohols; polyvinyl acetates; polyvinyl pyrrolidones including copolymers of polyvinyl pyrrolidone and polyvinyl acetate; gelatin; silyl-modified polyvinyl alcohol; styrene-butadiene copolymer; acrylic polymer latexes; ethylene-vinyl acetate copolymers; polyurethane resin; polyester resin; and combination thereof. In some examples, the binder is polyvinylalcohol with percentage hydrolysis between 80 to 90% and 4% viscosity higher than 30 cps at 25° C. Examples of binders include Poval®235, Mowiol®56-88, Mowiol®40-88 (products of Kuraray and Clariant). In some examples, the binder may be present in an amount representing of about 5 wt % to about 30 wt % by total weight of the ink-absorbing layer (120).

The printable media (101) contains a supporting substrate (110) that acts as a bottom substrate layer. The ink-absorbing layer (120) forms a coating layer on said supporting substrate (110) and, in other word, forms a recording material that is well adapted for inkjet printing device. The supporting substrate (110) may take the form of a sheet, a web, or a three-dimensional object of various shapes. The supporting substrate (110) can be of any type and size. The supporting substrate (110) can be any material that will be able to provide a mechanical support to the above mentioned layers. In some examples, the supporting substrate can be a flexible film or a rigid paper substrate. As non-limiting examples, the supporting substrate (110) may be selected from cellulosic or synthetic paper (coated or uncoated), cardboard, polymeric film (e.g. plastic sheet like PET, polycarbonate, polyethylene, polypropylene), fabric, cloth and other textiles. The bottom substrate layer may be single material plastic film made from PET, polyimide or another suitable polymer film with adequate mechanical properties. In some examples, the supporting substrate (110) includes any substrate that is suitable for use in digital color imaging devices, such as electrophotographic and/or inkjet imaging devices, including, but in no way limiting to, resin coated papers (so-called photobase papers), papers, overhead projector plastics, coated papers, fabrics, art papers (e.g. water color paper), plastic film of any kind and the like. The substrate includes porous and non-porous surfaces. In some examples, the supporting substrate (110) is paper (non-limitative examples of which include plain copy paper or papers having recycled fibers therein) or photopaper (non-limitative examples of which include polyethylene or polypropylene extruded on one or both sides of paper) and/or combinations thereof. The supporting substrate (110) can be a photobase. Photobase is a coated photographic paper, which includes a paper base extruded one or both sides with polymers, such as polyethylene and polypropylene. Photobasic support can include a photobase material including a highly sized paper extruded with a layer of polyethylene on both sides. In this regard, the photobase support is an opaque water-resistant material exhibiting qualities of silver halide paper. In some examples, the photobase support includes a polyethylene layer having a thickness of about 10 to 2.4 grams per square meter (g/m² or gsm). The photobase support can also be made of transparent or opaque photographic material.

In some examples, the ink-absorbing layer (120) is disposed on the supporting substrate (110) and forms a coating layer having a coat weight which is in the range of about 10 to about 75 gram per square meter (g/m² or gsm) per side. In some other examples, the coat weight of the ink-absorbing layer (120) is in the range of about 10 to about 40 gram per square meter (g/m² or gsm) per side. The supporting substrate (110) can have a thickness along substantially the entire length ranging between about 0.025 mm and about 0.5 mm.

In some examples, the printable medium can include a glossy porous layer (150). Said layer (150) is a protective porous layer that could be applied above the ink-absorbing layer (120). When present, the glossy protective layer (150) is a porous layer having pore diameters that are smaller than the average size of the metal oxide particles that are present in the first composition. In some examples, the coat weight of the glossy layer (150) can be from about 0.1 g/m² to about 2 g/m². The glossy layer (150) can contain inorganic colloidal particles such as colloidal particles of metal oxides and semi-metal oxides or colloidal silica particles and water-binders, such as polyvinylalcohol or copolymers of vinylpyrrolidone. The average particle size, as measured by diameter, of the inorganic colloidal particles, can be from about 5 nm to about 150 nm. Inorganic colloidal particles can be selected from the group consisting of silica, clay, kaolin, calcium carbonate, talc, titanium dioxide and zeolites. In some examples, the inorganic colloidal particles are colloidal silica particles. The glossy layer (150) can contain binders. Such binders can be polyvinylalcohol or copolymer of vinylpyrrolidone.

The preceding description has been presented only to illustrate and describe embodiments of the present disclosure. However, it is to be understood that the following are only illustrative of the application of the principles of the present articles and methods.

### EXAMPLES

### Example 1

### Ink Compositions

A first ink composition A is prepared based on dispersions containing Fe₃O₄ nanoparticles. The dispersion is produced by milling nanoparticle Fe₃O₄ powder (Inframat Advanced Materials, Manchester Conn.) in a Ultra Apex Mill® UAM-015 (Kotobuki industries Co., LTD, Kure, Japan) with a dispersant, Silquest®A1230 (Momentive Performance Materials, Columbus, USA) at a dispersant/metal oxide particles ratio equal to 0.5. The resulting dispersion contains about 5.5 wt % of Fe₃O₄ particles. The average particle size of Fe₃O₄ particles is about 32 nm as measured by a Nanotrack® particle size analyzer (Microtrac Corp., Montgomeryville, USA). The dispersion is then used to produce the first ink composition A as summarized in TABLE 1. Second ink compositions B1, B2 and B3 are based on magenta, cyan, and Black dyes, and are prepared as summarized in TABLE 1.

TABLE 1

Ink Formulation #

| | A | B1 | B2 | B3 |
|---|---|---|---|---|
| Fe₃O₄ Dispersion | 36.20 | — | — | — |
| LEG-1 | 5.00 | 5.00 | 5.00 | 5.00 |
| 2-Pyrrolidinone | 9.00 | 9.00 | 9.00 | 9.00 |
| Trizma ® Base | 0.20 | 0.20 | 0.20 | 0.20 |
| Proxel ® GXL | 0.10 | 0.10 | 0.10 | 0.10 |
| Surfynol ® 465 | 0.20 | 0.20 | 0.20 | 0.20 |
| Reactive Red 180 | — | 1.5 | — | — |
| Acid Red 52 | | 1.5 | | |
| Direct Blue 199 | — | — | 2.5 | — |
| Reactive Black 31 | — | — | — | 3.0 |
| Water | Up to | Up to | Up to | Up to |
| | 100% | 100% | 100% | 100% |

LEG-1 is a branched ethylene glycol (available from Liponics Technologies, West Sacramento Calif.). Proxel®GXL is a biocide (available from Arch Chemicals, Norwalk Conn.). Surfynol®465 is a surfactant from Air Products and Chemicals, Inc., Allentown Pa., Acid Red 52 (AR 52) is magenta colorant from Sensient Technologies (Carlsbad, Calif., USA).

### Example 2

### Printable Media

A printable recording medium is produced with a single pass (wet-on-wet) coating method using a curtain coater. An ink-absorbing layer and, eventually, a glossy layer are applied onto a photobase (“HP Advanced PhotoPaper”) as supporting substrate (166 or 171 g/m² raw base paper). The ink-absorbing layer is applied first to the front side of the photo paper with a roller coater. When present, the glossy layer is coated on the top of the ink-absorbing layer. The coat weight of the absorbing layer is 28 gsm and the coat weight of the glossy layer is 0.5 gsm. The formulations of the different coating layers are expressed in the TABLE 2 below. Each numbers represent the part per weight of each components present in each layer.

TABLE 2

| Layer | Ingredients | Media (α) | Media (β) |
|---|---|---|---|
| Glossy protective layer | Disperal ® HP-14 | 75 | — |
| | Cartacoat ® K303C | 25 | — |
| | PVA 2 | 11 | — |
| Coat-weight | | 0.5 gsm | — |
| Ink-absorbing layer | Treated Silica | 100 | 100 |
| | PVA 1 | 21 | 21 |
| | Boric Acid | 2.5 | 2.5 |
| | Silwet ® L-7600 | 0.5 | 0.5 |
| | Glycerol | 1.5 | 1.5 |
| | Zonyl ® FSN | 0.1 | 0.1 |
| Coat-weight | | 28 gsm | 28 gsm |

Treated silica is Cab-O-Sil®MS-55(available from Cabot) treated with ACH and Silquest®A-1110. PVA 1 is Poval®235 available from Kuraray. PVA 2 is Mowiol® 40-88 available from Kuraray. Zonyl®FSN is a fluorosurfactants available from DuPont Inc. Cartacoat®K303C is cationic colloidal silica available from Clariant. Disperal®HP-14 is boehmite available from Sasol technologies Inc. Silwet®L-7600 is a surfactant from GE silicone Inc.

### Example 3

### Printing Methods and Printed Articles

Ink compositions A and B, such as described in TABLE 1, are printed on the print media (α), such as described in TABLE 2. The printer used is HP Photosmart® 8450 (Hewlett Packard, Palo Alto Calif.). Ink A is printed from HP 94 cartridges. Inks B are printed from HP 97 cartridges (dye-based Cyan and Magenta inks) and HP 99 cartridges (dye-based black ink). Three printing methods I, II and III are used. In the method I, the second ink composition is jetted first and then the first ink composition is jetted, on the same area, in a separate printhead carriage pass. In the method II, the first ink composition is jetted first and, then, the second ink composition is jetted, on the same area, in a separate printhead carriage pass. In the method III, the first and the second ink compositions are jetted simultaneously, on the same area, in the same printhead carriage pass. The flux of the ink composition A (containing metal oxide particles) is, at 72 pL/300^{th}, of about 10000 pL/mm. The particles deposition density is of about 20 μg/cm². The flux of ink compositions B1, B2 and B3 (containing soluble colorants) is varying. Such variations are illustrated in TABLE 3.

The resulting printed articles, produced by the three different methods described above, are studied by analyzing Photographs (200× magnification). In all methods, light-absorbing colorant dots do not spread significantly, which indicates rapid penetration of the dye into media absorbing layer. All printed articles have enhance colored and metallic appearance. One hour after printing, the printed article reflectivity (at 20°) is measured using BYK “Micro-Tri-Gloss meter”.

The visual color appearance and print reflectivity data of the printed articles produced at different ink fluxes ratio, using method III, are summarized in TABLE 3. Such TABLE 3 illustrates thus the impact of the fluxes of ink compositions A, B1, B2 and B3 on reflectivity and on metallic color appearance of the resulting printed articles. All printed articles have wide color variation and strong directional light reflectivity (above 10%), i.e. strong metallic appearance. (For reference, 20° reflectivity of the non-printed article or printed only with B inks only is 1 to 1.5%).

TABLE 3

| Ink A flux | Ink B1 flux | Ink B2 flux | Ink B3 flux | Reflectivity | Visual metalized |
|---|---|---|---|---|---|
| (in pL/300^{th}) | (in pL/300^{th}) | (in pL/300^{th}) | (in pL/300^{th}) | at 20° (%) | Color Appearance |
| 72 | 0 | 0 | 0 | 16.1 | Gold-yellow |
| 72 | 1.6 | 0 | 0 | 15.8 | Reddish-Yellow |
| 72 | 8 | 0 | 0 | 15.3 | Copper |
| 72 | 0 | 8 | 0 | 16.0 | Green-Yellowish |
| 72 | 0 | 20 | 0 | 14.8 | Yellowish-Gray |
| 72 | 0 | 8 | 20 | 13.5 | Greenish-Gray |
| 72 | 8 | 20 | 0 | 15.8 | Pinkish-Gray |

1. A method for producing printed articles comprising:
a. providing a first ink composition that contains metal oxide particles with an average particle size in the range of about 3 to about 300 nm;
b. providing a second ink composition that contains non-particulate, light-absorbing colorants dissolved in an ink vehicle;
c. providing a printable media having a bottom supporting substrate and an ink-absorbing layer with pore diameters that are smaller than the size of the metal oxide pigment particles;
d. and applying, on the same print area, the first and the second ink compositions onto said printable media.

2. The method of claim 1 wherein the first and the second ink compositions are applied simultaneously on the same print area of the printable media.

3. The method of claim 1 wherein the first ink composition is applied before the second ink composition on the same print area of the printable media.

4. The method of claim 1 wherein the first ink composition is applied after the second ink composition on the same print area of the printable media.

5. The method of claim 1 wherein the first and the second inkjet compositions are applied via inkjet printing technique.

6. The method of claim 1 wherein the metal oxide particles, that are present in the first ink composition, have an average particle size ranging from about 10 to about 100 nm.

7. The method of claim 1 wherein the metal oxide particles, that are present in the first ink composition, are iron oxide pigment particles (Fe₃O₄).

8. The method of claim 1 wherein the metal oxide particles, present in the first ink composition, are dispersed with polyether alkoxysilanes dispersants.

9. The method of claim 1 wherein the printable media further includes a glossy porous layer above the ink-absorbing layer.

10. The method of claim 1 wherein the second ink composition comprises light-absorbing colorants an amount representing from about 0.001 to about 10 wt % by total weight of the second ink composition.

11. The method of claim 1 wherein the second ink composition comprises non-particulate, light-absorbing colorants that are selected from the group consisting of yellow dyes, cyan dyes, magenta dyes, and combinations of two or more of the above.

12. A printed article, resulting from the printing method of claim 1, comprising a printable media on which a printed feature has been firmed by applying, on the same print area, a first and a second ink composition, wherein:
a. said first ink composition contains metal oxide particles that have an average particle size in the range of about 3 to about 300 nm and forms a metal oxide coating layer;
b. said second ink composition contains non-particulate, light-absorbing colorants dissolved in an ink vehicle and forms a colorant absorbed area;
c. and wherein said printable media, contains a bottom supporting substrate and an ink-absorbing layer with pore diameters that are smaller than the size of the metal oxide pigment particles.

13. The printed article of claim 12 wherein:
a. the first ink composition forms a metal oxide coating layer at the surface of the ink-absorbing layer of the printable media;
b. and wherein the second ink composition forms a colorant absorbed area into the ink-absorbing layer and below the metal oxide coating layer.

14. The printed article of claim 12 wherein the first ink composition forms, onto the printable media, a metal oxide coating layer that has a thickness that is between about 1 nm and about 600 nm.

15. The printed article of claim 12 wherein the first ink composition forms, onto the printable media, a metal oxide coating layer that has a density in the range of about 3 to about 80 μg/cm².
